(19) United States
(12) Patent Application Publication
(10) Pub. No.: US 2025/0369789 A1
(43) Pub. Date: Dec. 4, 2025

(54) Device for Flow Sequencing and Metering

(71) Applicant: DeltaValve, LLC, Sandy, UT (US)

(72) Inventor: Filiberto Jimenez, Sandy, UT (US)

(21) Appl. No.: 19/224,571

(22) Filed: May 30, 2025

Related U.S. Application Data
(60) Provisional application No. 63/653,673, filed on May 30, 2024.

(51) Int. Cl. G01F 11/22; G01F 15/00; G01F 15/12

(52) U.S. Cl. CPC G01F 11/22; G01F 15/005; G01F 15/12

(57) ABSTRACT

A metering device with a rotor inside a housing configured to isolate an upstream source, such as a reactor, form an output to atmosphere. The rotor rotates within the housing. The plate is placed within the housing between the rotor and the top of the housing and between the rotor and the bottom of the housing. The plate has a port through which steam passes to clear process fluid from the cylinder to the output. Steam regulates the temperature of the actuator and the components. Steam also activates the plate to improve the seal between the plate and the rotor.

### CROSS-REFERENCE TO RELATED APPLICATIONS

This application claims benefit of U.S. Provisional Patent Application No. 63/653,673 filed May 30, 2024.

### BACKGROUND OF THE INVENTION

### 1. Field of the Invention

The present invention relates to isolating a quantity of process fluid, and more particularly to sequentially releasing and metering material flow through a process.

### 2. Background and Related Art

A plant's ability to meter process fluid released from a high temperature reactor impacts the quality of the process fluid as well as the profitability of the plant. Valves can be utilized to meter material flows. However, materials and designs limit valve function in high temperature environments. High temperature limitations of existing rotary valves present premature failures. Service life is too short and there is a need for a new device to meter bulk material from the reactor. Valve failure often requires the reactor to be shut off, costing the plant money in lost productivity, cycling the reactor, and equipment repairs. A need exists to reliably dispense metered process fluid to a conveyor in an extreme temperature as great as 950° C. A further need exists to cool the valve. A further need exists to purge process fluid from the valve. A need exists for a metering device which can isolate an upstream port when the down stream port is dumping to atmosphere.

### BRIEF SUMMARY OF THE INVENTION

The general purpose of the systems and methods disclosed herein is to provide an improved rotary valve for metering process fluid, while also promoting valve durability. Specifically, the metering valve will receive material from a source, such as a high-temperature reactor in predetermined quantities and dispense each quantity. The overall apparatus contains a body, a rotor configured to rotate within the body, a first containment plate disposed adjacent a first side of the rotor and a second containment plate disposed adjacent a second side of the rotor. This apparatus is designed to work in conjunction with a variety of existing high-temperature reactors including cement, but it could also be included in conjunction with a new refinery structure.

In one non-limiting embodiment, a device for metering material. A high temperature rotary valve with an input, and an output. Some embodiments may comprise cylinders in a rotor inside a body. Some embodiments may comprise a plate between the rotor and the body on the input side of the body. Some embodiments may comprise a plate between the rotor and the output side of the body. Some embodiments may be gravity fed and/or have a steam vent opposite the output port to help clear the chamber of material when it is aligned with the output. Other embodiments may comprise steam chamber above the cylinders formed between the rotating body and the containment plate. The valve can be used in high temp, low pressure applications and the body and/or the stem is steam cooled. Actuator stem may be steam cooled.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a metering device.

FIG. 2 shows a partially exploded view of the metering device with the cylinders exposed.

FIG. 3 shows a profile view of the metering device.

FIG. 4 shows a cross-sectional view of the metering device.

FIG. 5 shows a partially exploded view of the bottom view of the metering device.

FIG. 6 shows a rotor.

FIG. 7 shows a containment plate with an orifice for an actuator and an orifice for an input or an output.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

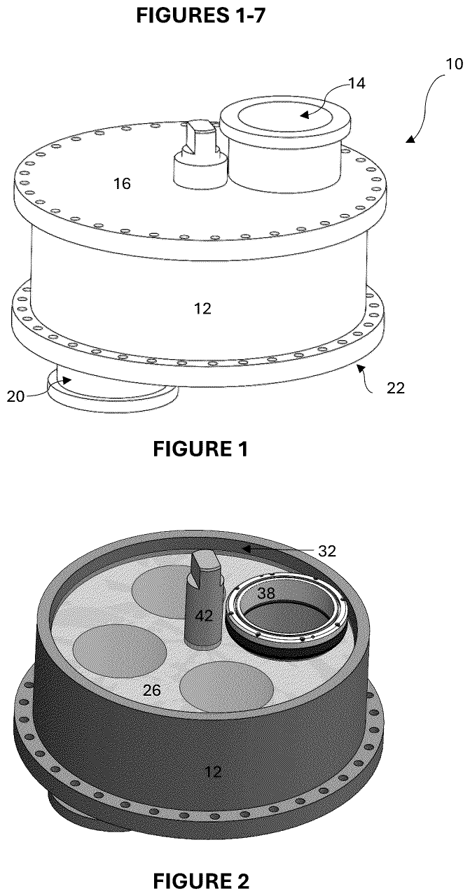

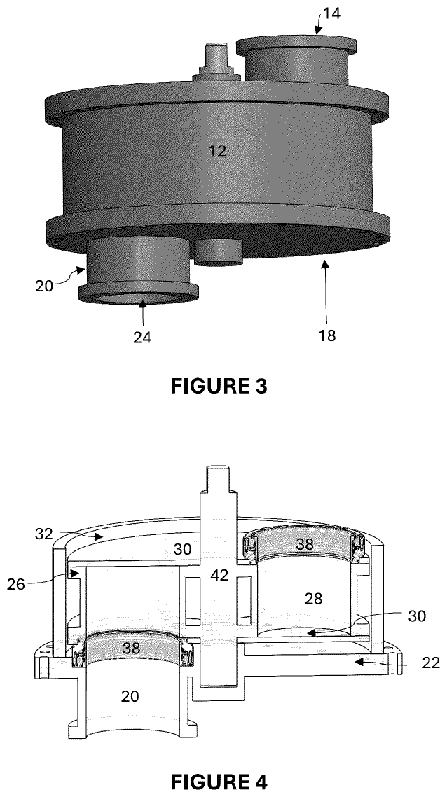

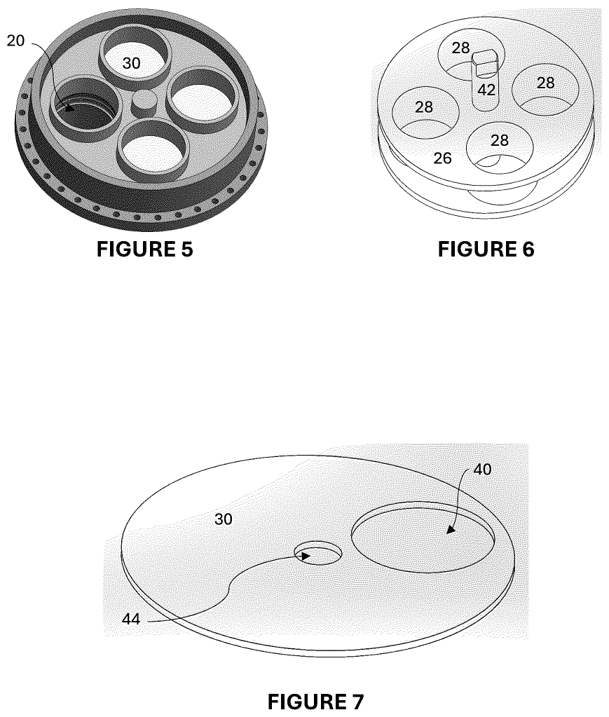

Referring now to FIGS. 1-7.

A gravity-fed rotary valve with an input and an output and configured to meter material flow. One general aspect includes a housing containing a rotor. In some embodiments the rotary valve also includes a housing. In some embodiments the valve also includes an input through a first side of the housing in a first alignment. In some embodiments the valve also includes an output through a second side of the housing in a second alignment. In some embodiments the valve also includes a rotor having a plurality of parallel chambers extending through the rotor where the rotor is configured to rotate within the housing. Implementations may include one or more of the following features. In some embodiments the rotary valve may include a first plate disposed between the first side of the housing and the rotor where the first plate may include an input port aligned with the input and may include a valve seat configured to proximate the rotor. In some embodiments the containment plate proximate the rotor.

One general aspect includes the rotary valve where the rotor is configured to rotate so as to periodically bring a first chamber in fluid communication with the input. In some embodiments the rotor is configured to rotate so as to periodically isolate the first chamber from the input. In some embodiments the rotor is configured to rotate so as to periodically place the chamber in fluid communication with the output. In some embodiments the rotor is configured to rotate so as to periodically isolate the rotor from the output.

One general aspect includes the rotary valve where a space formed between the first plate and the rotor forms a steam chamber.

One general aspect includes the rotary valve where the first plate further may include a port aligned with the output.

One general aspect includes, the rotary valve also includes a housing. The valve also includes a rotor disposed within the housing the rotor may include a plurality of chambers. In some embodiments the valve also includes a plate disposed within the housing adjacent the rotor, the plate further may include an input port and a stem orifice where a steam chamber is formed between the plate and the rotor. In some embodiments the valve also includes a valve seat disposed within the input port and proximate the surface of rotor. In some embodiments the valve also includes an output port offset from the input port.

In some embodiments a metering device comprising a housing with an input port in a first vertically aligned position and an output port in a second vertically aligned position. In some embodiments the metering device further comprises a rotor disposed inside the housing. In some embodiments the rotor further comprises a plurality of vertically-oriented cylinders.

In some embodiments the rotor rotates inside the housing. In some embodiments the rotation comprises four positions: a first position in communication with the input port; a second position which is isolated from the input port and the output port; a third position in communication with the output port; and a fourth position isolated from the input port and the output port. In some embodiments the rotor continuously rotates. In some embodiments the rotor continually rotates.

In some embodiments a first plate is disposed between the side of the housing with the input port and the rotor. In some embodiments a collar is placed between the input port and the surface of the plate facing the housing.

In some embodiments a second plate is placed between the side of the housing and the output and the rotor. In some embodiments an actuator stem extends through the housing to the rotor.

In some embodiments the temperature of the actuator stem is regulated using steam. In some embodiments the temperature of the rotor is regulated using steam. In some embodiments the temperature of the housing is regulated using steam. In some embodiments the temperature of the first plate is regulated using steam. In some embodiments the temperature of the second plate is regulated using steam.

In some embodiments the steam is used to activate the first plate to bias against the rotor. In some embodiments steam is used to activate the first plate to bias against the housing. In some embodiments the steam is used to activate the second plate to bias against the rotor. In some embodiments steam is used to activate the second plate to bias against the housing.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A rotary valve comprising:
a housing;
an input through a first side of the housing in a first alignment;
an output through a second side of the housing in a second alignment; and
a rotor having a plurality of chambers extending through the rotor wherein the rotor is configured to rotate within the housing.

2. The rotary valve of claim 1 wherein the rotor is configured to rotate so as to periodically bring a first chamber in fluid communication with the input.

3. The rotary valve of claim 2 wherein the rotor is configured to rotate so as to periodically isolate the first chamber from the input.

4. The rotary valve of claim 1 wherein the rotor is configured to rotate so as to periodically place the chamber in fluid communication with the output.

5. The rotary valve of claim 1 wherein the rotor is configured to rotate so as to periodically isolate the rotor from the output.

6. The rotary valve of claim 1 further comprising a first plate disposed between the first side of the housing and the rotor wherein the first plate comprises an orifice aligned with the input and further comprising a valve seat proximate the rotor.

7. The rotary valve of claim 6 wherein a space formed between the first plate and the rotor forms a steam chamber.

8. The rotary valve of claim 1 further comprising a containment plate disposed between the rotor and the second side of the housing the containment plate further comprising an output orifice aligned with the output wherein the containment plate proximate the rotor.

9. The rotary valve of claim 1 further comprising a second plate disposed between the rotor and the second side of the housing.

10. The rotary valve of claim 9 wherein the second plate further comprises an orifice aligned with the output.

11. A rotary valve comprising:
a housing comprising a first side having an input and a second side having an output;
a rotor disposed within the housing the rotor further comprising a plurality of chambers;
a first non-rotating plate disposed within the housing and adjacent the rotor wherein the first non-rotating plate further comprises an orifice and a stem orifice wherein a steam chamber is formed between the first non-rotating plate and the rotor; and
a valve seat disposed between an output orifice in the first non-rotating plate and the first side wherein the valve seat is configured to maintain a pressure above an atmospheric pressure.

12. The rotary valve of claim 11 wherein the valve is configured to be gravity fed.

13. The rotary valve of claim 11 wherein the valve is configured to be steam purged.

14. The rotary valve of claim 11 wherein the rotor is configured to rotate at about 10 revolutions per minute.

15. The rotary valve of claim 11 wherein the housing is configured to be steam cooled.

16. The rotary valve of claim 11 further comprising a stem wherein the stem is configured to be steam cooled.

17. The rotary valve of claim 11 wherein the housing is configured to be steam cooled.

18. A rotary valve comprising:
a housing;
an input through a first side of the housing in a first alignment;
an output through a second side of the housing in a second alignment;
a rotating body having a plurality of chambers extending through the rotating body
wherein the rotating body is configured to rotate within the housing; and
a first non-rotating plate having a first orifice configured to align with one of the plurality of chambers as the rotating body rotates around a central stem defining a central axis and a second orifice configured to receive a stem.
